(19) United States
(12) Patent Application Publication
(10) Pub. No.: US 2013/0174025 A1
(43) Pub. Date: Jul. 4, 2013

(54) VISUAL COMPARISON OF DOCUMENT VERSIONS

(71) Applicants: Keng Fai Lee, Cupertino, CA (US); Wing Hung Chan, Hong Kong (HK); Ka Lok Li, Hong Kong (HK); Sidney Hok Nang Fong, Hong Kong (HK); Siu Lung Tam, Hong Kong (HK); Wang Chiu Chan, Hong Kong (HK); Pui Ki Chan, Palo Alto, CA (US); Oi Ying Angela Lee, Emeryville, CA (US)

(72) Inventors: Keng Fai Lee, Cupertino, CA (US); Wing Hung Chan, Hong Kong (HK); Ka Lok Li, Hong Kong (HK); Sidney Hok Nang Fong, Hong Kong (HK); Siu Lung Tam, Hong Kong (HK); Wang Chiu Chan, Hong Kong (HK); Pui Ki Chan, Palo Alto, CA (US); Oi Ying Angela Lee, Emeryville, CA (US)

(21) Appl. No.: 13/340,519

(22) Filed: Dec. 29, 2011

(51) Int. Cl. G06F 17/00

(52) U.S. Cl. 715/251

(57) ABSTRACT

Visual comparison of document versions is described. In some implementations, versions of a document can be quickly displayed using a single user input. In some implementations, a displayed page of a version of the document can be replaced by a corresponding page of another version of the document.

### TECHNICAL FIELD

The disclosure generally relates to document editing.

### BACKGROUND

Creating, maintaining and storing multiple versions of a document is common practice. Maintaining multiple versions of a document allows users or editors of the document to look at the history of a document and review the changes that were made to the document.

### SUMMARY

Visual comparison of document versions is described. In some implementations, versions of a document can be quickly displayed using a single user input. In some implementations, a displayed page of a version of the document can be replaced by a corresponding page of another version of the document.

Particular implementations provide at least the following advantages: A user can use visual memory to quickly identify differences in different versions of the same document. A user can quickly and easily navigate between document versions.

Details of one or more implementations are set forth in the accompanying drawings and the description below. Other features, aspects, and potential advantages will be apparent from the description and drawings, and from the claims.

### DESCRIPTION OF DRAWINGS

FIG. 1 illustrates an example graphical interface for displaying document versions.

FIG. 2 illustrates an example graphical interface for navigating pages within a version of a document.

FIG. 3 illustrates an example graphical interface for navigating between document versions.

FIG. 4 illustrates different versions of the same page of a document.

FIG. 5 illustrates visual comparison of document versions by page replacement.

FIG. 6 is flow diagram of an example process for visual comparison of document versions.

FIG. 7 is a block diagram of an exemplary system architecture implementing the features and processes of FIGS. 1-6.

Like reference symbols in the various drawings indicate like elements.

### DETAILED DESCRIPTION

### Displaying Document Versions

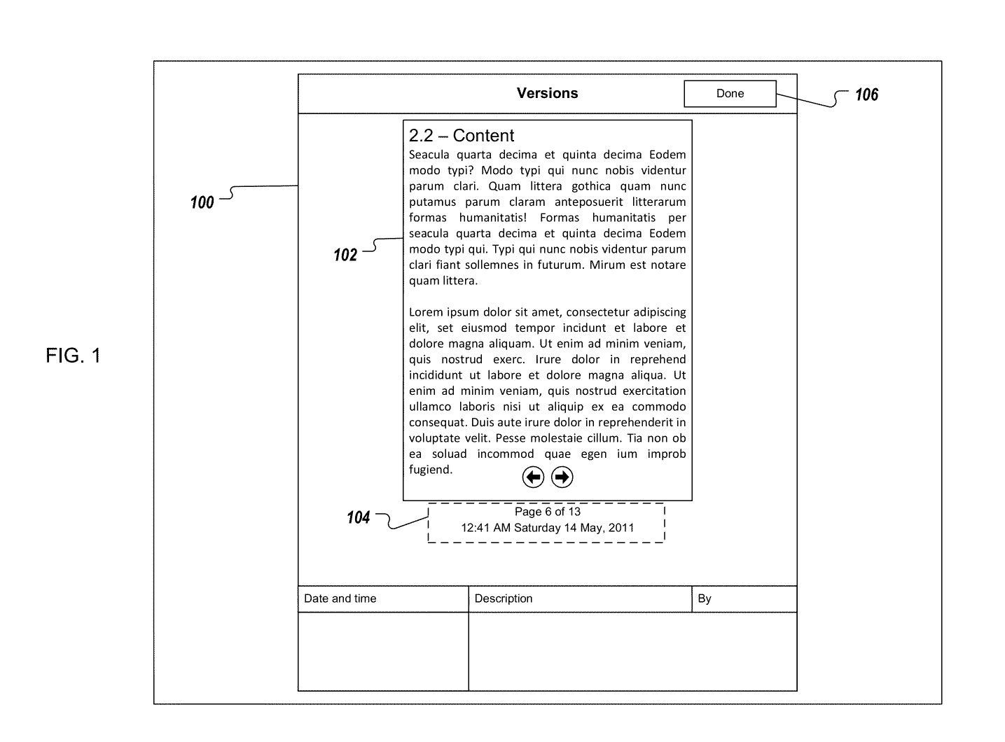

FIG. 1 illustrates an example graphical interface 100 for displaying document versions. For example, graphical interface 100 can be presented on the display of a computing device, such as a laptop computer, desktop computer, tablet computer, smartphone or any other computing device. In some implementations, as a document is edited, modified, or changed, version of the document can be generated and stored. The versions can be generated in response to a trigger event (e.g., a significant change in the content of the document), based on a time interval (e.g., a predetermined amount of time has lapsed since the last version was generated), or in response to a user action (e.g., the user can directly cause the generation of a new version by pressing a button or selecting a menu item). Once generated, the document versions can be stored on locally on the computing device or on a remote networked device. Versions can be created and viewed for any type of document. For example, a word processing document, a web document (e.g., HTML), a spreadsheet document, or a multimedia document (e.g., slides) can each be associated with different versions of the document. The versions of each type of document can be navigated and viewed using the systems and processes described herein.

In some implementations, graphical interface 100 can be invoked from a document editor application. For example, graphical interface 100 can be displayed in response to the selection of a graphical element (e.g., button, menu item, etc.) of the document editing application. Graphical interface 100 can include content display area 102. For example, content display area 102 can display an image of a page of the document. In some implementations, when graphical interface 100 is invoked, the most recent document version will be displayed. For example, a page from the current working document version can be displayed in content display area 102.

In some implementations, graphical interface 100 can include information area 104. For example, information area 104 can display information about the content currently displayed in content display area 102. Information area 104 can include page number information, such as the page number of the displayed page and the total number of pages in the document. Information area 104 can include document version information, such as a date and time corresponding to when the displayed document version was generated. In some implementations, as the content in content display area 102 is changed, the information in information area 104 can be updated to display information associated with the displayed content. For example, if the next page is displayed (e.g., page 7), information area 104 will be updated to indicate that page 7 is currently displayed. If a different version of the document is displayed, information area 104 will be updated to display version information associated with the displayed document version.

In some implementations, a user can return to the document editing application by selecting graphical element 106. For example, graphical element 106 can be a button which, when selected, causes graphical interface 100 to close. When graphical interface 100 closes, the document editing application can be displayed.

### Document Page Navigation

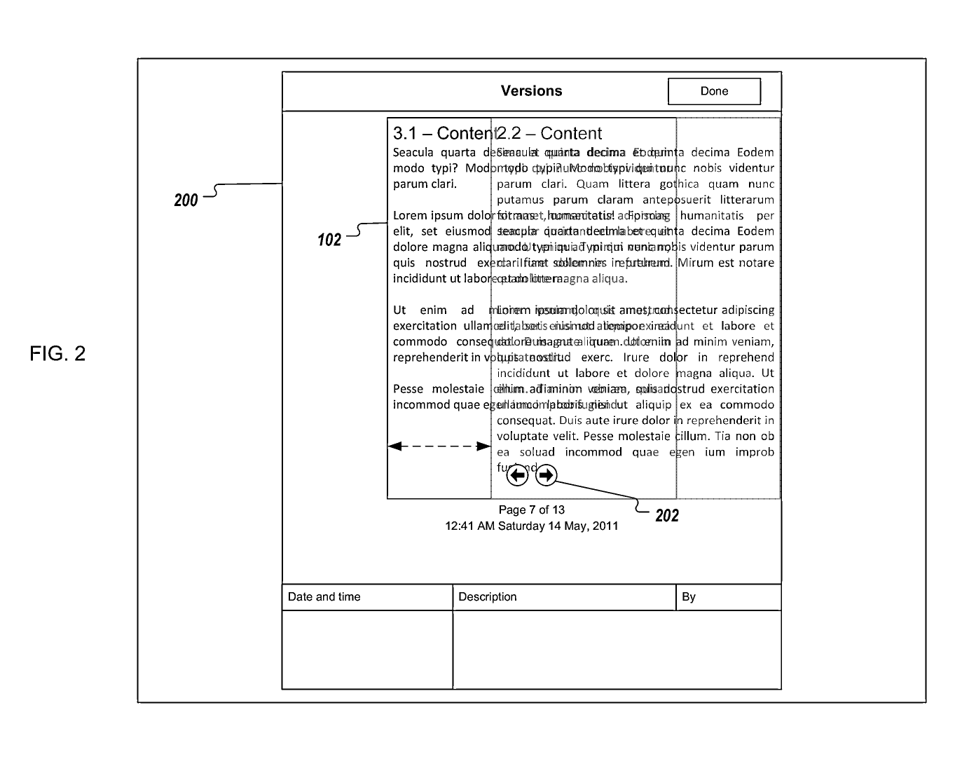

FIG. 2 illustrates an example graphical interface 200 for navigating pages within a version of a document. In some implementations, a user can change which page of a document version is viewed in content display area 102. For example, the user can provide input to change which page is displayed in content display area 102 for a particular document version (e.g., the current working version).

In some implementations, a user can provide input through an input device to cause a different page of the document version to be displayed. For example, the user can use right and left arrow keys to display the next page or the previous page of a version of a document. If the computing device is configured to process touch input, a gesture (e.g., left swipe, right swipe) can be provided by the user to cause the previous page or next page of the document version to be displayed. In some implementations, a user can select one of graphical elements 202 (e.g., right arrow button, left arrow button) to cause the previous or next page of a document version to be displayed. In some implementations, changing pages does not change which version of the document is displayed. For example, a user can sequentially display the pages within a selected version of the document by providing keyboard or touch input, as described above.

In some implementations, a page change animation can be displayed when navigating between pages of a document version. For example, when a user provides input to display the next page of a document version, the current page can be animated so that it appears to slide off of content display area 102, as illustrated by FIG. 2. The animation can appear as if the current page is sliding off the next page which is lying beneath the current page. When a user provides input to display the previous page of a document version, the previous page can appear to slide onto and cover the current page. For example, the previous page can appear to enter view from the edge of graphical interface 200 and slide over and cover the current page of the document version, as illustrated by FIG. 2.

In some implementations, a user will select a portion of a document to view. For example, spreadsheet applications may not organize content into discrete pages. The units of a spreadsheet file are often worksheets or the like. Often worksheets can include a large amount of data over a large display area. If the worksheet is scaled down to fit within content display area 102, the items within the worksheet may be too small to view and compare. Thus, in some implementations a user will be able to select a portion of a worksheet to compare between versions. For example, a user can use right and left arrow keys (or left and right swipe touch input gestures) to move between worksheets of a spreadsheet file. Within a worksheet, a user can scroll to an area of the worksheet using a combination of keyboard keys (e.g., control button and arrow keys) to display the area of the worksheet within content display area 102.

Alternatively, a user can use a pointer device and a cursor to drag the desired worksheet area into view on content display area 102. For example, the user can click on the portion of the worksheet displayed in content display area 102 and drag the portion of the worksheet out of content display area 102 to display a different portion of the worksheet. In some implementations, interactive graphical elements (e.g., vertical and horizontal scroll bars) can be presented to allow a user to display different portions of a worksheet within content display area 102.

### Document Version Navigation

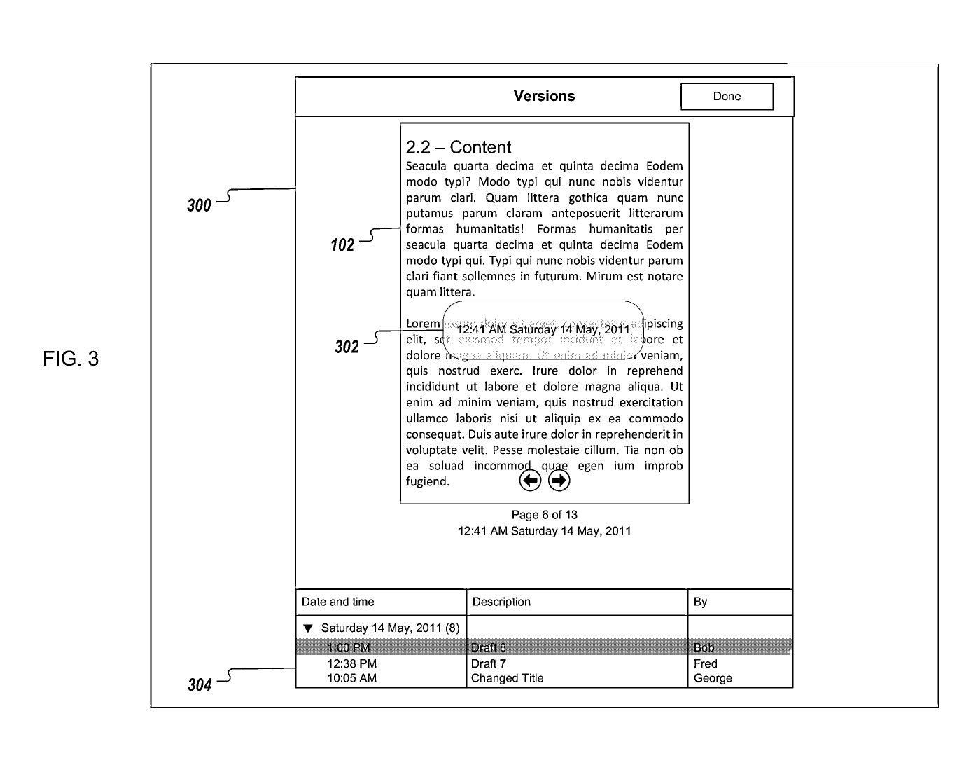

FIG. 3 illustrates an example graphical interface 300 for navigating between document versions. In some implementations, a user can navigate between document versions using a single user input. For example, a user can provide input through an input device (e.g., keyboard, touch interface, mouse, etc.) to change which version of a document is displayed in content area 102 of graphical interface 300. A user can press the up and down arrows on a keyboard to navigate between document versions, for example. A user can provide touch input in the form of a swipe gesture (e.g., swipe up or swipe down) to navigate between document versions. A user can use a mouse scroll wheel to navigate between document versions, for example. In some implementations, up (e.g., up arrow key, upward swipe, up scroll wheel movement, etc.) can correspond to a command to view the next document version (e.g., move forward in time). In some implementations, down (e.g., down arrow key, downward swipe, down scroll wheel movement, etc.) can correspond to a command to view the previous document version (e.g., move back in time).

In some implementations, the same page or portion of the document is displayed when navigating between document versions. For example, if page five (5) is displayed for a currently displayed document version and an up arrow key input is received, page five (5) of the next (or previous) document version will be displayed. In some implementations, the page of the next (or previous) document version will replace the page of the currently displayed document version within content display area 102. Likewise, if a portion of a spreadsheet worksheet is displayed in content display area 102, the same portion (e.g., location) of the worksheet will be displayed when the user navigates between versions of the spreadsheet.

In some implementations, graphical interface 300 can include graphical element 302. For example, graphical element 302 can be a heads-up display that presents information about the currently displayed version of the document. Graphical element 302 can be an opaque or semi-transparent overlay displayed over content display area 102, for example. Graphical element 302 can include date and time information corresponding to when the version of the document was generated, for example.

In some implementations, graphical interface 300 can include version information area 304. For example, version information area 304 can present a list of the available versions of the document. Version information area 304 can display document version information including a date and time when each version was generated, a description of each document version and a user who caused the document version to be generated. In some implementations, as a user navigates through document versions (e.g., using up arrow key or down arrow key), the document version information corresponding to the currently displayed document version can be highlighted in version information area 304.

### Visual Comparison By Page Replacement

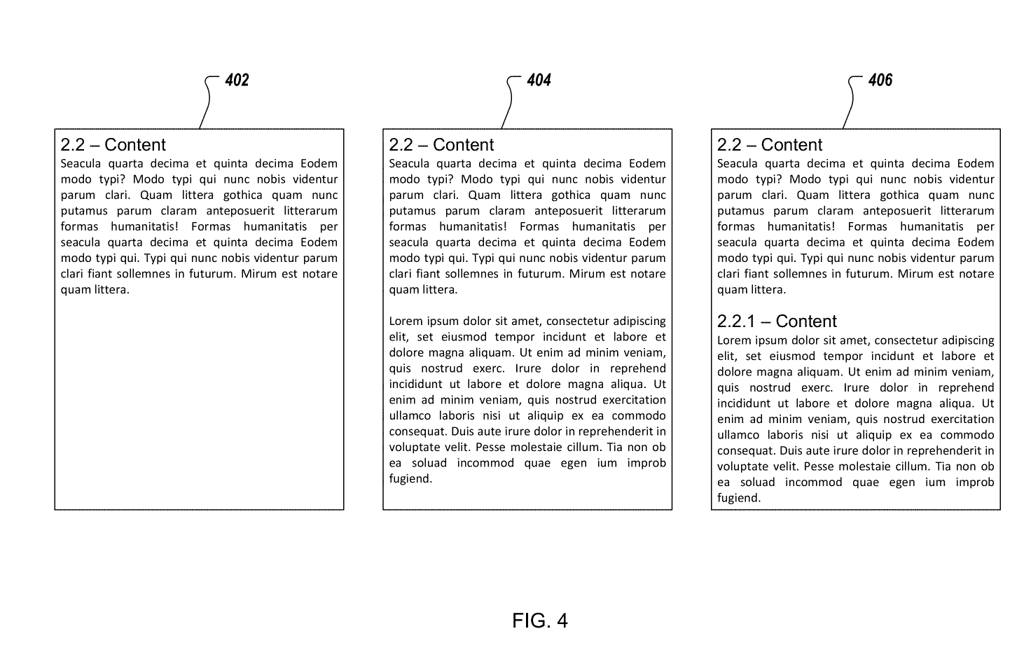

FIG. 4 illustrates different versions 402, 404, 406 of the same page of a document. For example, versions 402, 404 and 406 can correspond to page seven of a document. The differences in the content between versions 402, 404 and 406 can be attributed to edits made to the document over time. For example, version 402 can be an initial version of the page of the document, version 404 can include changes made to version 402 and version 406 can include changes made to version 404. A user can navigate between versions 402, 404 and 406 using graphical interface 300 of FIG. 3 and review the evolution of the document over time.

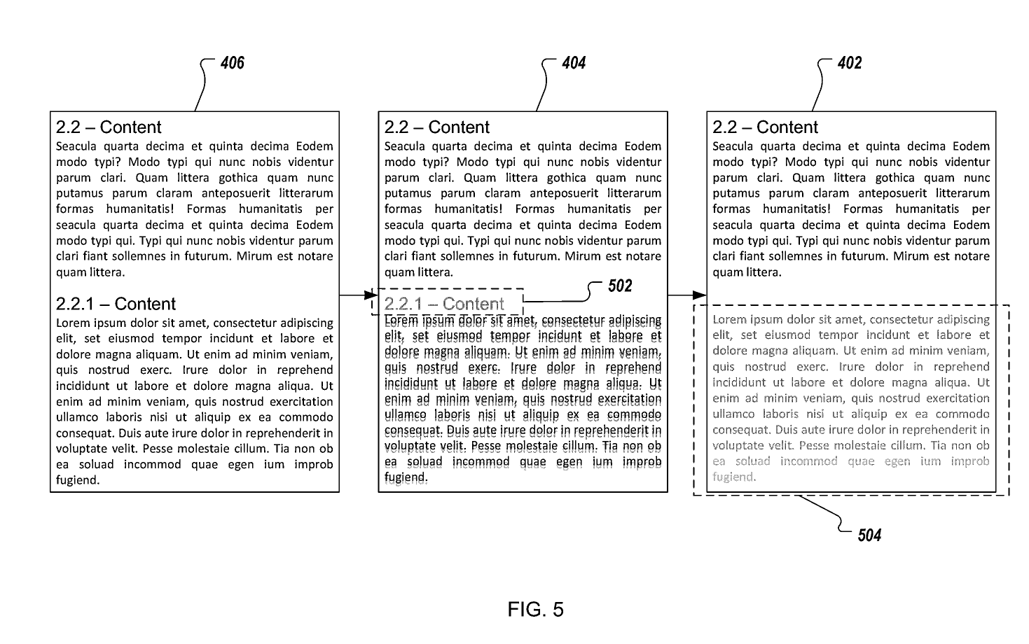

FIG. 5 illustrates visual comparison of document versions by page replacement. For example, as a user navigates between document page versions 402, 404 and 406, the version being navigated to will immediately replace the version being navigated from. As the user navigates back in time from version 406 to version 404, the page associated with version 404 will replace the page associated with version 406, for example. By immediately replacing the currently displayed version with the next (or previous) version, the user can quickly identify changes between versions using visual memory. For example, as the user navigates from version 406 to version 404, the user's visual memory will allow the user to quickly identify that content 502 is missing from version 404. Thus, the user can identify that content 502 was added in version 406. Similarly, as the user navigates from version 404 to version 402, the user's visual memory will allow the user to quickly identify that content 504 is missing from version 402. Thus, the user can identify that content 504 was added in version 404.

### Example Process

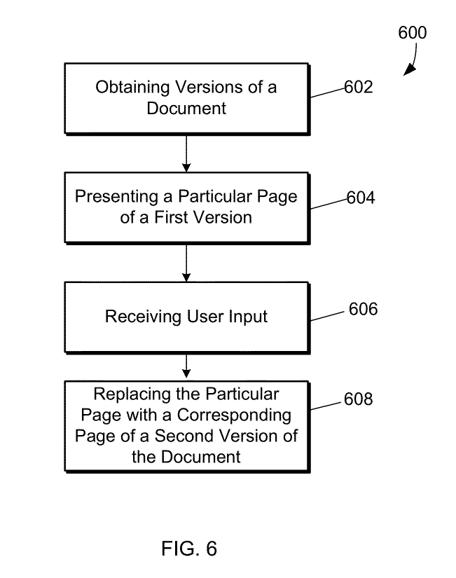

FIG. 6 is flow diagram of an example process 600 for visual comparison of document versions. At step 602, versions of a document are obtained. For example, a document can be associated with many versions. Each version of the document can be a snapshot of the document at a point in time during the development or evolution of the document. The document versions can be obtained in response to a user invoking a document versions interface, such as graphical interface 100 of FIG. 1.

At step 604, a particular page or portion of a first version of the document can be presented. For example, if the document versions interface has just been invoked from a document editing application, the version of the document displayed can be the current working version of the document and the page or portion displayed can be the page or portion currently being edited or displayed in the document editing application. If the user has performed document version navigation operations within the document versions interface, then the version of the document displayed can be the version of the document that the user navigated to most recently and the page of the document displayed can be the page of the document that the user navigated to most recently.

At step 606, user input can be received. In some implementations, page navigation input can be received. For example, a user can provide input to right or left arrow keyboard keys to navigate between pages of a version of a document. In some implementations, document version navigation can be received. For example, a user can provide input to up or down arrow keyboard keys to navigate between versions of a document. Other input, such as touch input gestures, can be used to navigate between pages and/or versions of a document, as described above.

At step 608, the particular page or portion of the first document version is replaced by a corresponding page or portion of a second version of the document. In some implementations, when document version navigation input is received (e.g., up arrow key input, down arrow key input), different versions of the same page or portion can be displayed. For example, page five of a first version of the document can be replaced by page five of a second version of the document so that the user can make a visual comparison of the different versions of page five of the document. For example, a particular portion or location within a worksheet of a first version of a spreadsheet can be replaced by a corresponding portion or location within a worksheet of a second version of the spreadsheet so that the user can make a visual comparison of the different versions of the particular portion or location of the spreadsheet worksheet.

### Example Mobile Device Architecture

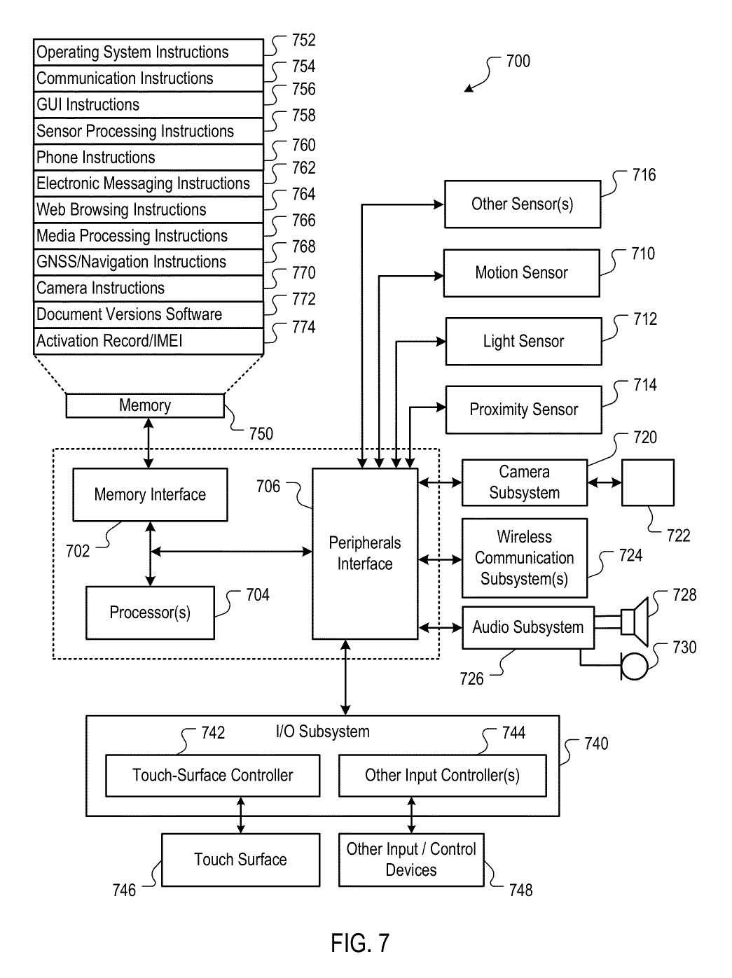

FIG. 7 is a block diagram 700 of an example computing device that can implement the features and processes of FIGS. 1-6. The mobile device 100 can include a memory interface 702, one or more data processors, image processors and/or central processing units 704, and a peripherals interface 706. The memory interface 702, the one or more processors 704 and/or the peripherals interface 706 can be separate components or can be integrated in one or more integrated circuits. The various components in the mobile device 100 can be coupled by one or more communication buses or signal lines.

Sensors, devices, and subsystems can be coupled to the peripherals interface 706 to facilitate multiple functionalities. For example, a motion sensor 710, a light sensor 712, and a proximity sensor 714 can be coupled to the peripherals interface 706 to facilitate orientation, lighting, and proximity functions. Other sensors 716 can also be connected to the peripherals interface 706, such as a global navigation satellite system (GNSS) (e.g., GPS receiver), a temperature sensor, a biometric sensor, or other sensing device, to facilitate related functionalities.

A camera subsystem 720 and an optical sensor 722, e.g., a charged coupled device (CCD) or a complementary metal-oxide semiconductor (CMOS) optical sensor, can be utilized to facilitate camera functions, such as recording photographs and video clips. The camera subsystem 720 and the optical sensor 722 can be used to collect images of a user to be used during authentication of a user, e.g., by performing facial recognition analysis.

Communication functions can be facilitated through one or more wireless communication subsystems 724, which can include radio frequency receivers and transmitters and/or optical (e.g., infrared) receivers and transmitters. The specific design and implementation of the communication subsystem 724 can depend on the communication network(s) over which the mobile device 100 is intended to operate. For example, a mobile device 100 can include communication subsystems 724 designed to operate over a GSM network, a GPRS network, an EDGE network, a Wi-Fi or WiMax network, and a Bluetooth™ network. In particular, the wireless communication subsystems 724 can include hosting protocols such that the device 100 can be configured as a base station for other wireless devices.

An audio subsystem 726 can be coupled to a speaker 728 and a microphone 730 to facilitate voice-enabled functions, such as speaker recognition, voice replication, digital recording, and telephony functions.

The I/O subsystem 740 can include a touch-surface controller 742 and/or other input controller(s) 744. The touch-surface controller 742 can be coupled to a touch surface 746. The touch surface 746 and touch-surface controller 742 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 746.

The other input controller(s) 744 can be coupled to other input/control devices 748, such as one or more buttons, rocker switches, thumb-wheel, infrared port, USB port, and/or a pointer device such as a stylus. The one or more buttons (not shown) can include an up/down button for volume control of the speaker 728 and/or the microphone 730.

In one implementation, a pressing of the button for a first duration can disengage a lock of the touch surface 746; and a pressing of the button for a second duration that is longer than the first duration can turn power to the mobile device 100 on or off. Pressing the button for a third duration can activate a voice control, or voice command, module that enables the user to speak commands into the microphone 730 to cause the device to execute the spoken command. The user can customize a functionality of one or more of the buttons. The touch surface 746 can, for example, also be used to implement virtual or soft buttons and/or a keyboard.

In some implementations, the mobile device 100 can present recorded audio and/or video files, such as MP3, AAC, and MPEG files. In some implementations, the mobile device 100 can include the functionality of an MP3 player, such as an iPod™ The mobile device 100 can, therefore, include a 36-pin connector that is compatible with the iPod. Other input/output and control devices can also be used.

The memory interface 702 can be coupled to memory 750. The memory 750 can include high-speed random access memory and/or non-volatile memory, such as one or more magnetic disk storage devices, one or more optical storage devices, and/or flash memory (e.g., NAND, NOR). The memory 750 can store an operating system 752, such as Darwin, RTXC, LINUX, UNIX, OS X, WINDOWS, or an embedded operating system such as VxWorks.

The operating system 752 can include instructions for handling basic system services and for performing hardware dependent tasks. In some implementations, the operating system 752 can be a kernel (e.g., UNIX kernel). In some implementations, the operating system 752 can include instructions for performing a visual comparison of document versions. For example, operating system 752 can implement the document version navigation and document page navigation features described with reference to FIGS. 1-6.

The memory 750 can also store communication instructions 754 to facilitate communicating with one or more additional devices, one or more computers and/or one or more servers. The memory 750 can include graphical user interface instructions 756 to facilitate graphic user interface processing; sensor processing instructions 758 to facilitate sensor-related processing and functions; phone instructions 760 to facilitate phone-related processes and functions; electronic messaging instructions 762 to facilitate electronic-messaging related processes and functions; web browsing instructions 764 to facilitate web browsing-related processes and functions; media processing instructions 766 to facilitate media processing-related processes and functions; GNSS/Navigation instructions 768 to facilitate GNSS and navigation-related processes and instructions; and/or camera instructions 770 to facilitate camera-related processes and functions.

The memory 750 can store document versions software instructions 772 to facilitate other processes and functions, such as the processes and functions as described with reference to FIGS. 1-6. The memory 750 can also store other software instructions (not shown), such as web video instructions to facilitate web video-related processes and functions; and/or web shopping instructions to facilitate web shopping-related processes and functions. In some implementations, the media processing instructions 766 are divided into audio processing instructions and video processing instructions to facilitate audio processing-related processes and functions and video processing-related processes and functions, respectively. An activation record and International Mobile Equipment Identity (IMEI) 774 or similar hardware identifier can also be stored in memory 750.

Each of the above identified instructions and applications can correspond to a set of instructions for performing one or more functions described above. These instructions need not be implemented as separate software programs, procedures, or modules. The memory 750 can include additional instructions or fewer instructions. Furthermore, various functions of the mobile device 100 can be implemented in hardware and/or in software, including in one or more signal processing and/or application specific integrated circuits.

What is claimed is:

1. A method comprising:
obtaining a plurality of versions of a document;
presenting a particular page of a first version of the document on a display of a computing device;
receiving a first user input; and
in response to the first user input, replacing the particular page of the first version of the document with a corresponding page of a second version of the document on the display of the computing device.

2. The method of claim 1, wherein the user input is a single input from an input device coupled to the computing device.

3. The method of claim 2, wherein the input device is a keyboard, and the single input corresponds to a key of the keyboard being pressed.

4. The method of claim 2, wherein the input device is a touch interface, and the single input corresponds to a gesture detected by the touch interface.

5. The method of claim 1, wherein the particular page and the corresponding page have identical page numbers.

6. The method of claim 1, further comprising:
displaying a semi-transparent overlay that presents version information for a version of the document that is currently displayed.

7. A non-transitory computer-readable medium including one or more sequences of instructions which, when executed by one or more processors, causes:
obtaining a plurality of versions of a document;
presenting a particular page of a first version of the document on a display of a computing device;
receiving a first user input; and
in response to the first user input, replacing the particular page of the first version of the document with a corresponding page of a second version of the document on the display of the computing device.

8. The computer-readable medium of claim 7, wherein the user input is a single input from an input device coupled to the computing device.

9. The computer-readable medium of claim 8, wherein the input device is a keyboard, and the single input corresponds to a key of the keyboard being pressed.

10. The computer-readable medium of claim 8, wherein the input device is a touch interface, and the single input corresponds to a gesture detected by the touch interface.

11. The computer-readable medium of claim 7, wherein the particular page and the corresponding page have identical page numbers.

12. The computer-readable medium of claim 7, wherein the instructions cause:
displaying a semi-transparent overlay that presents version information for a version of the document that is currently displayed.

13. A system comprising:
one or more processors; and
a non-transitory computer-readable medium including one or more sequences of instructions which, when executed by the one or more processors, causes:
obtaining a plurality of versions of a document;
presenting a particular page of a first version of the document on a display of a computing device;
receiving a first user input; and
in response to the first user input, replacing the particular page of the first version of the document with a corresponding page of a second version of the document on the display of the computing device.

14. The system of claim 13, wherein the user input is a single input from an input device coupled to the computing device.

15. The system of claim 14, wherein the input device is a keyboard, and the single input corresponds to a key of the keyboard being pressed.

16. The system of claim 14, wherein the input device is a touch interface, and the single input corresponds to a gesture detected by the touch interface.

17. The system of claim 13, wherein the particular page and the corresponding page have identical page numbers.

18. The system of claim 13, wherein the instructions cause:
displaying a semi-transparent overlay that presents version information for a version of the document that is currently displayed.
